(19) United States
(12) Patent Application Publication
(10) Pub. No.: US 2011/0198453 A1
(43) Pub. Date: Aug. 18, 2011

(54) COLLAPSIBLE DISPOSABLE TOOTHBRUSH HOLDER AND BLANK THEREFOR

(76) Inventor: Donald J. Volk, Turlock, CA (US)

(21) Appl. No.: 12/708,267

(22) Filed: Feb. 18, 2010

(51) Int. Cl. A46B 17/08; G09F 3/04; G09F 23/00

(52) U.S. Cl. 248/111; 40/672; 428/12

(57) ABSTRACT

Collapsible and disposable containers and stands, and blanks for forming such containers and stands, for holding and supporting toothbrushes, the blank being formable into either a flattened structure that can be expanded into the holder or into the expanded holder.

### BACKGROUND OF THE INVENTION

1. Field of the Invention

This invention relates generally to containers and stands for holding and supporting elongated items and relates more specifically to collapsible and disposable containers and stands, and blanks for forming such containers and stands, for holding and supporting toothbrushes.

2. Prior Art

Toothbrush holders are known, especially ceramic and plastic toothbrush holders present in the household bathroom. Toothbrush holders hold and support toothbrushes off of the counter for both health and aesthetic reasons. A vertically supported toothbrush dries more quickly and accumulates fewer germs than a toothbrush lying on the bathroom sink counter, and just looks better.

Hotels, inns, cruise ships, medical facilities and the like typically do not provide a toothbrush holder and patrons have a choice: prop their toothbrush up in a glass, leave the toothbrush lying on the counter, place the toothbrush on a towel, or dry the toothbrush and place it back in the toiletry kit. None of these options are particularly appealing.

Various toothbrush holders, disposable and non-disposable, have been developed. Several representative devices include:

U.S. Pat. No. 2,902,145 to Wagner, which discloses a flat, compact case having a plurality of apertures in an upper wall through which the shanks or handles of toothbrushes may be extended, the case standing upright on a suitable surface, and with the heads of the brushes extended above the top of the case. The device further contemplates the provision of a trough-shaped bottom for maintaining the brushes uniformly in place in the holder and which bottom is provided with openings for drainage purposes. This is not a collapsible disposable device made from a blank.

U.S. Pat. No. 3,233,743 to Di Tirro, which discloses a molded one piece box-like rack having a pair of parallel integral sides and back and adapted to be mounted in vertical planes. The spaced sides include cooperating pairs of downwardly inclined horizontally aligned slots for supporting a comb therein. This also is not a collapsible device made from a blank.

U.S. Pat. No. 5,687,855 to Heller, which discloses a disposable toothbrush holder, particularly for the convenience and hygiene of visitors in motels and hotels, holds toothbrushes upright, bristle end up, for sanitary drying, supported in circular openings in a convex upper portion supported by integrally-formed legs. The holders can be molded economically from recyclable plastic material, and can be nested together for space-efficient packaging. This also is not a collapsible device made from a blank.

U.S. Pat. No. 7,228,976 to Pretorius, which discloses a toothbrush holder including a single piece of sheet material including spaced first and second end edges. A single fold area across the sheet material defines a holder portion and a base portion. The holder portion terminates in the first end edge and has a length relative to the base portion to impart a smooth sloping curvature to the holder portion without fold lines when the toothbrush holder is deployed. The base portion terminates at the second end edge. At least one toothbrush receiving orifice in the holder portion is sized to receive the shaft of the toothbrush. A key extends outwardly from the second edge, and a lock for receiving the key is disposed in the holder portion. The lock is spaced from the first end edge to angle the base portion and to deploy and support the holder portion in a position spaced from the base portion with the orifice in the base portion elevated. This is a device made from a blank but is not a box-like structure.

US Design Patent No. D570,144 to Scofield, which discloses an ornamental design for a disposable toothbrush holder that, in effect, has the appearance of a birdhouse or small house. The design has at least one hole in the “roof” of the design through which a toothbrush may be placed and held in a generally vertical orientation.

There is thus a need for an inexpensive collapsible disposable toothbrush holder for meeting the needs of hotels and other inns, cruise ships, travel kits, households, hospitals and other medical facilities, camps, schools, emergency management organizations, and the like.

### BRIEF SUMMARY OF THE INVENTION

The present invention is a collapsible, disposable toothbrush holder formed from a blank. The blank can be a flat piece of cardboard comprising panels and fold lines, some of the panels being tabs. Certain of the panels are folded along the fold lines and at least one panel is glued or otherwise adhered to another panel to form the collapsed structure, namely a flattened pre-form. The flattened pre-form can be expanded to form a box-like structure and others of the panels, specifically the tabs, can cooperate with the expanded structure to form the finished or formed toothbrush holder.

The finished toothbrush holder has a generally truncated pyramidal shape with a rectangular, preferably square, base, and a rectangular, preferably square, top. The sides, preferably four sides and trapezoidal in shape, angle inward from base to top. The top has holes or perforations leading to the interior of the holder through which a portion of the toothbrush(es), preferably the handle(s) or shank(s), pass. In a preferred usage, when the toothbrush is in the holder, at least a majority portion of the toothbrush handle is located within the interior of the holder and at least the brush portion of the toothbrush is located outside of the holder. The rim or edge of the holes or perforations supports the toothbrush such that the toothbrush is in a generally vertical orientation, plus or minus 0-40 degrees or so, and the holes or perforations prevent the toothbrush from falling over. An interior panel can extend vertically and diagonally across the interior of the holder so as to divide the interior into two sections and so as to provide a resting surface for the toothbrush so as to prevent the toothbrush from resting at too great of an angle from vertical.

The holder can be stored and shipped in the flattened condition. When ready for use, the holder can be expanded and formed into the finished or formed holder and used. The holder can be a hygienically and useful complementary item used by hotels and the like, and can sport advertising or other promotional material on the sides. The holder also can be used by the traveler, by campers, by vacationers and the like. Similarly, the holder can be used by hospitals and other medical facilities and emergency management organizations and the like to help prevent the spread of germs and diseases by providing for a clean, disposable toothbrush holder for each visitor to the facility. Optionally, the holder can have advertising printed thereon.

These features, and other features and advantages of the present invention, will become more apparent to those of ordinary skill in the relevant art when the following detailed description of the preferred embodiments is read in conjunction with the appended drawings in which like reference numerals represent like components throughout the several views.

### BRIEF DESCRIPTION OF THE DRAWINGS

FIG. 1 is a perspective view of an assembled toothbrush holder according to the present invention.

FIG. 2 is a top view of the embodiment of the assembled toothbrush holder shown in FIG. 1.

FIG. 3 is a side view of the embodiment of the assembled toothbrush holder shown in FIG. 1.

FIG. 4 is a view of a blank for forming the toothbrush holder shown in FIG. 1.

FIG. 5 is a first view of the assembled blank shown in FIG. 4 in a flattened configuration.

FIG. 6 is a second view of the assembled blank shown in FIG. 4 in a flattened configuration.

FIG. 7 is a perspective view of a partially assembled container according to the present invention.

FIG. 8 is a top view of a partially assembled container according to the present invention.

FIG. 9 is a side view of a partially assembled container according to the present invention illustrating representative assembly steps.

FIG. 10 is a sectional top view of the embodiment of the assembled toothbrush holder along line 10′-10′ of FIG. 3.

FIG. 11 is a bottom view of an embodiment of the assembled toothbrush holder according to the present invention.

FIG. 12 is a top view of an alternate embodiment of the assembled toothbrush holder according to the present invention.

FIG. 13 is a top view of an alternate embodiment of the assembled toothbrush holder according to the present invention.

FIG. 14 is a top view of an alternate embodiment of the assembled toothbrush holder according to the present invention.

FIG. 15 is a view of a blank for forming an alternate embodiment of the tooth brush holder according to the present invention.

FIG. 16 is a perspective view of an assembled toothbrush holder according to the present invention formed from the blank of FIG. 15.

FIG. 17 is a top view of the embodiment of the assembled toothbrush holder shown in FIG. 16.

FIG. 18 is a side view of the embodiment of the assembled toothbrush holder shown in FIG. 16.

### DETAILED DESCRIPTION OF PREFERRED EMBODIMENTS

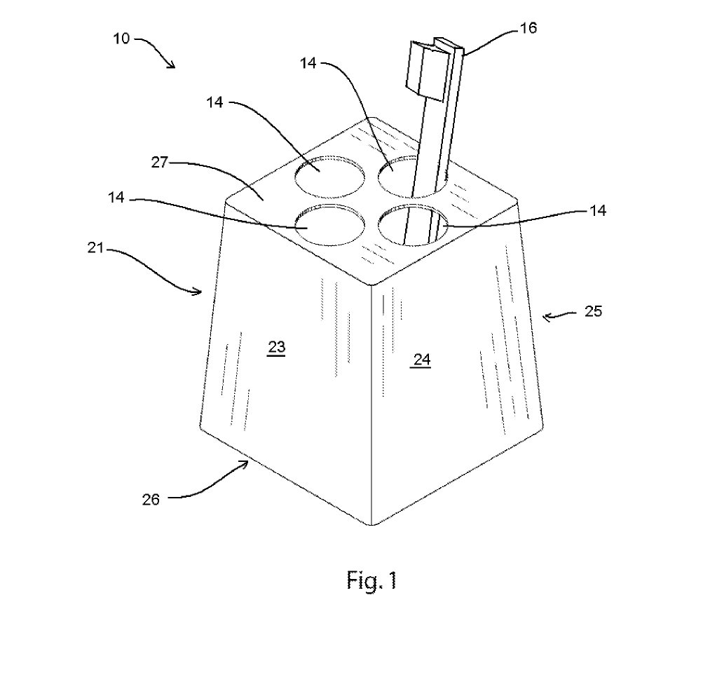

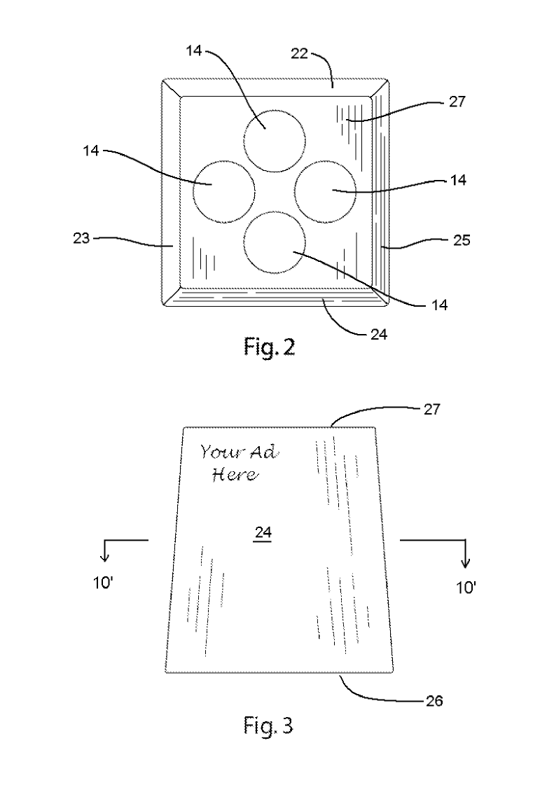

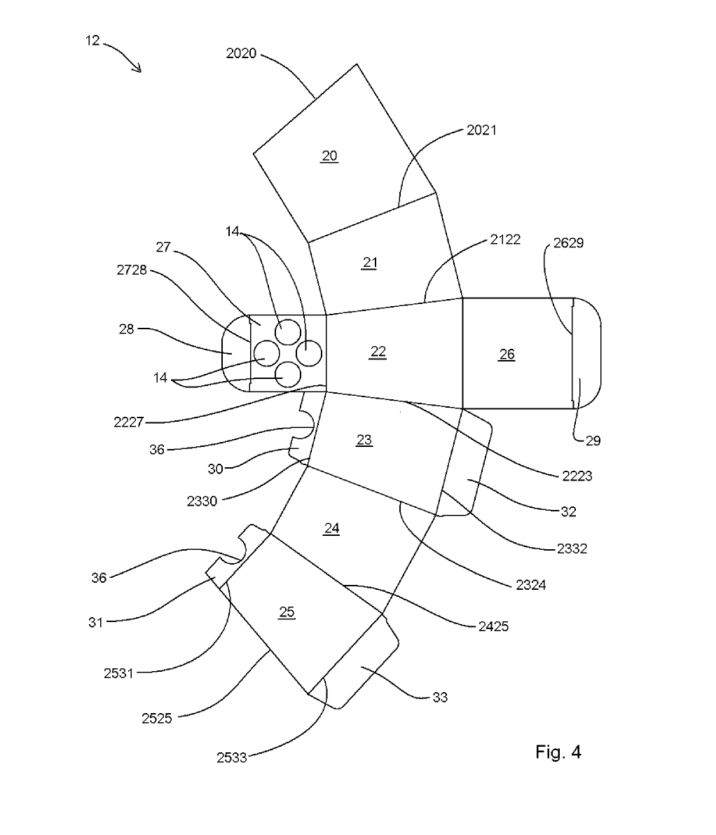

The present invention will now be described with reference to the accompanying drawings. FIG. 1 is a perspective view of an assembled toothbrush holder according to the present invention. FIG. 2 is a top view and FIG. 3 is a side view of this embodiment. FIG. 4 is a view of a blank for forming the toothbrush holder shown in FIG. 1. This embodiment is a general basic embodiment of the invention.

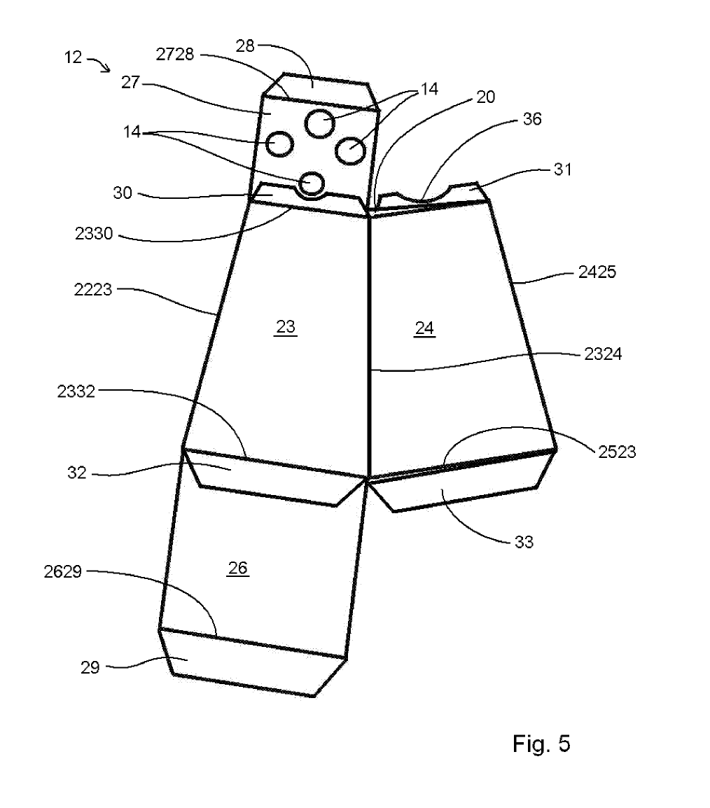

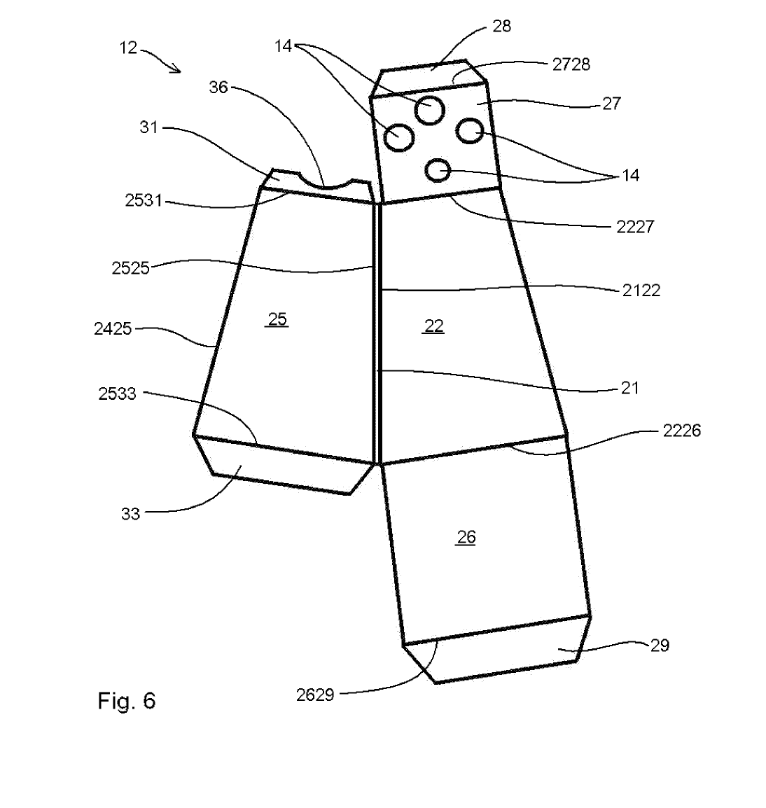

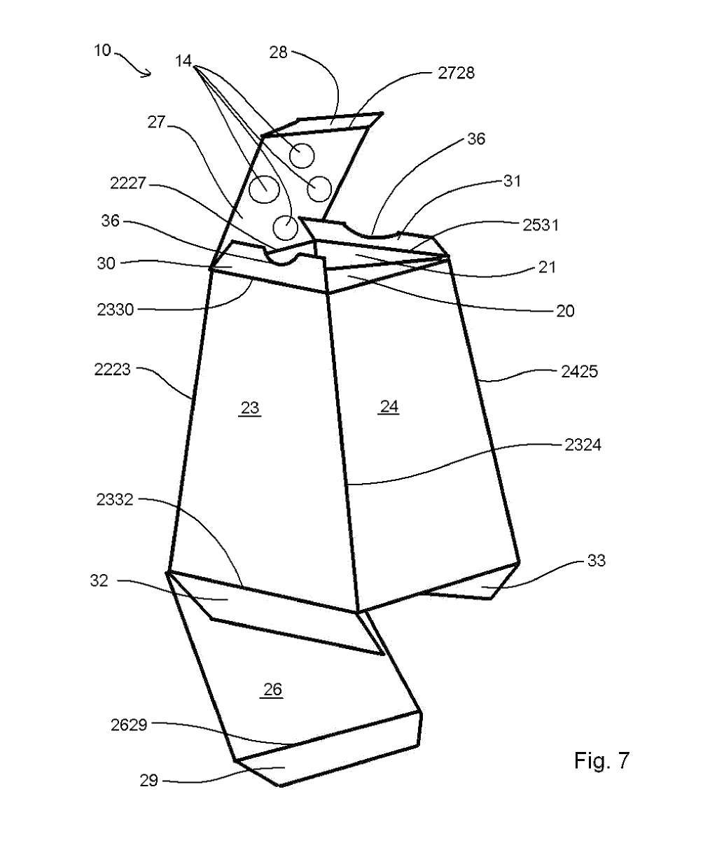

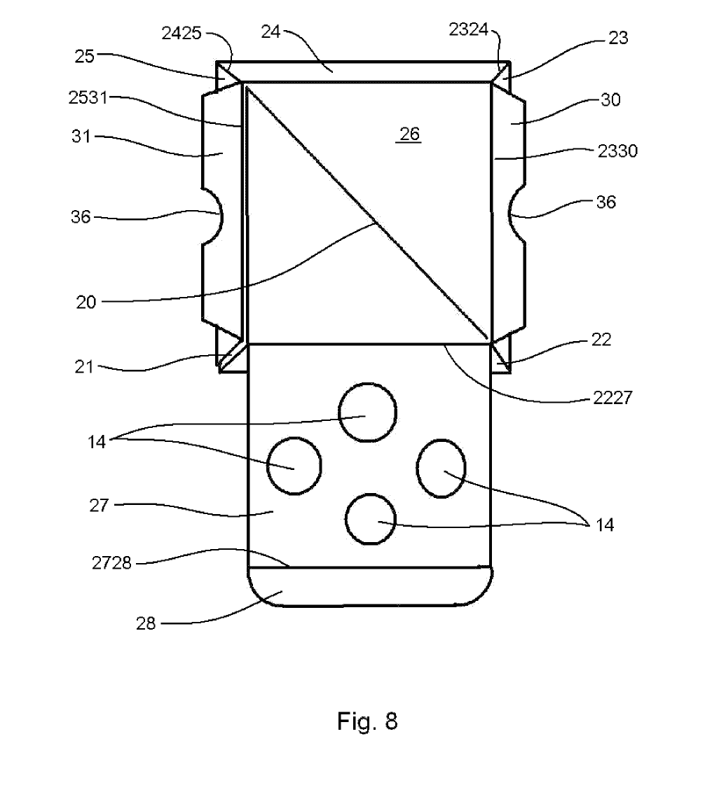

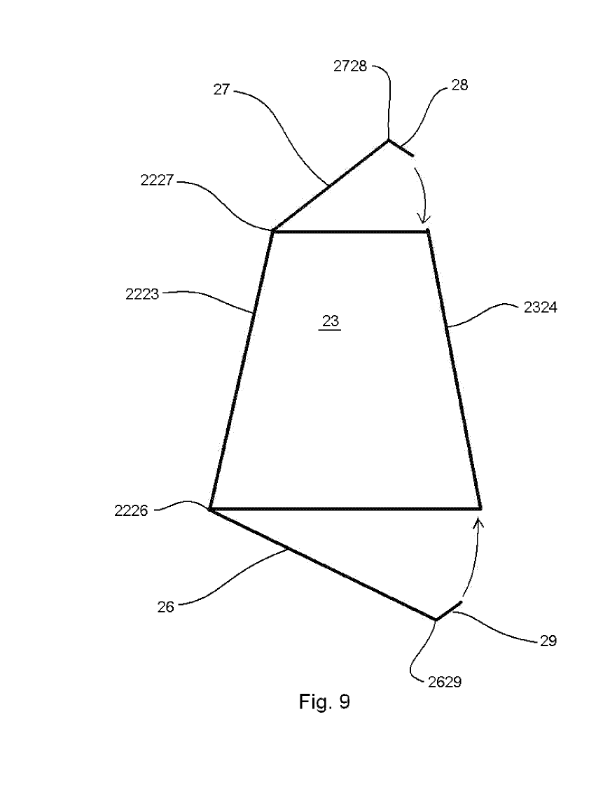

FIG. 5 is a first view and FIG. 6 is a second view of the assembled blank shown in FIG. 4 in a flattened configuration. This is a storage or shipping configuration that can be expanded and formed into the final assembled toothbrush holder. FIG. 7 is a perspective view of a partially assembled container according to the present invention. FIG. 8 is a top view and FIG. 9 is a side view of a partially assembled container according to the present invention. These views illustrate representative assembly steps for forming the toothbrush holder from the blank.

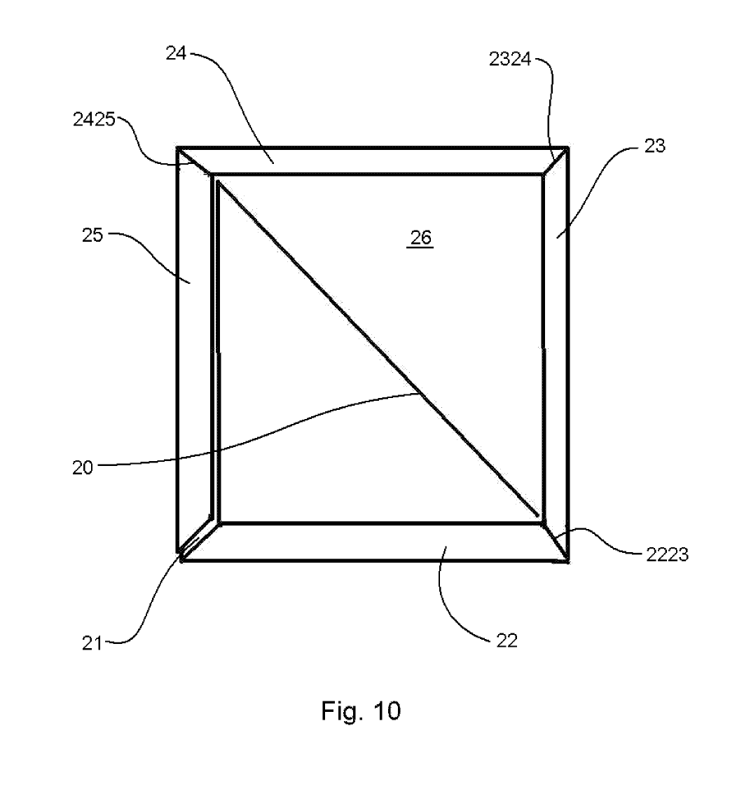

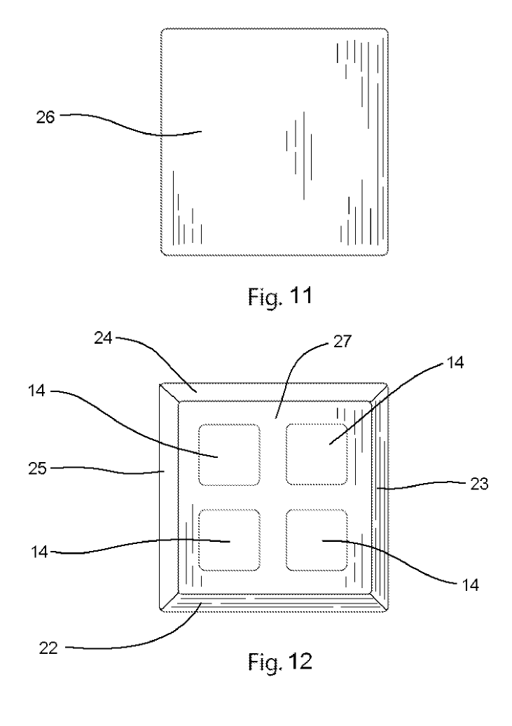

FIG. 10 is a sectional top view of the embodiment of the assembled toothbrush holder along line 10′-10′ of FIG. 3. This view illustrates how the sides are glued together so as to form a completed toothbrush holder. FIG. 11 is a bottom view of an embodiment of the assembled toothbrush holder according to the present invention.

FIGS. 12 through 14 are top views of an alternate embodiments of the assembled toothbrush holder according to the present invention. These views illustrate various alternative ornamental toothbrush receiving hole structures.

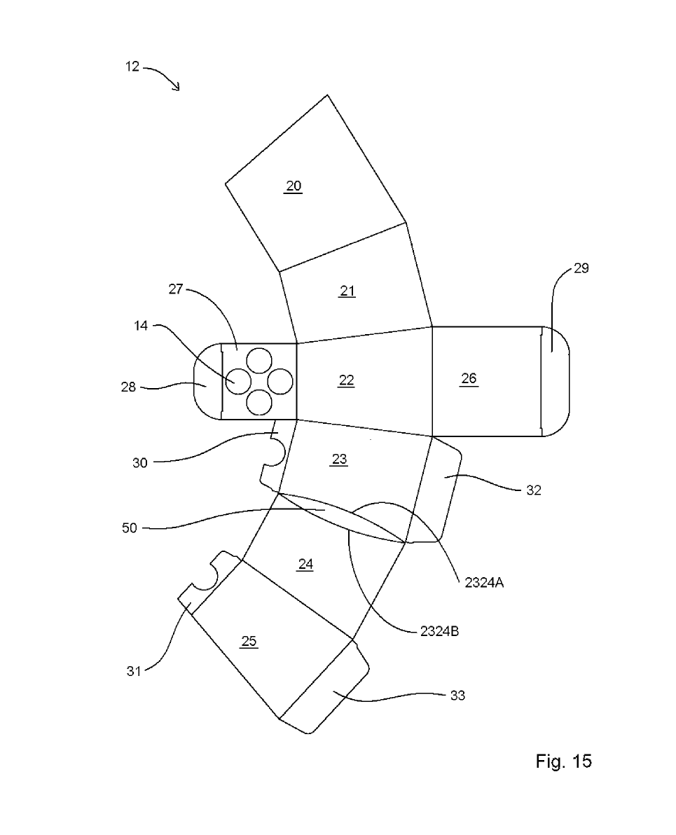

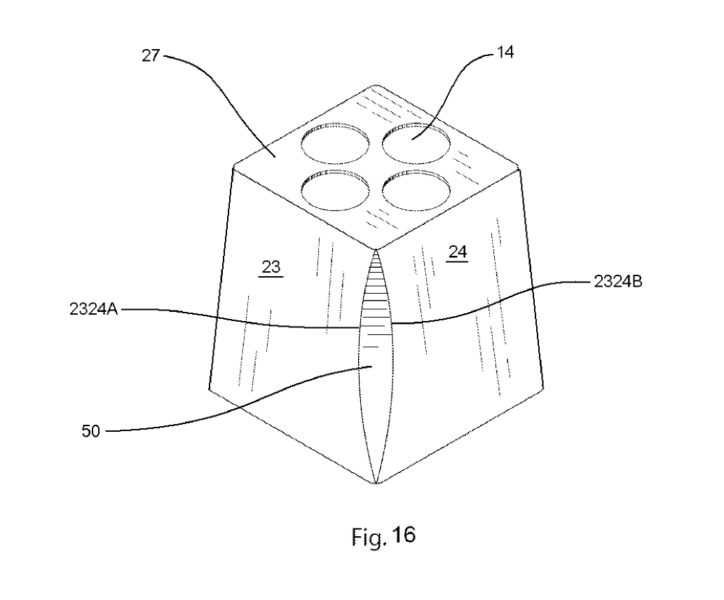

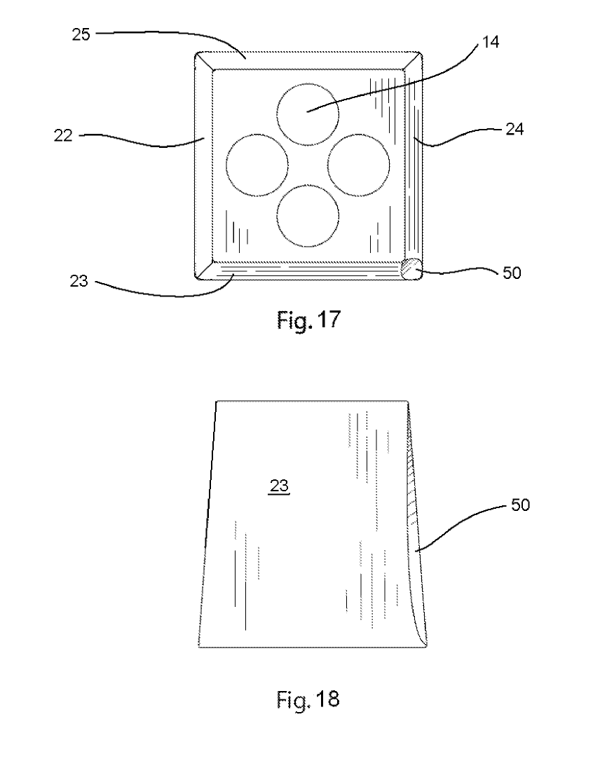

FIG. 15 is a view of a blank for forming an alternate embodiment of the tooth brush holder according to the present invention. As shown in more detail in FIGS. 16-18, this embodiment comprises an ornamental inwardly curved side edge. FIG. 16 is a perspective view of an assembled toothbrush holder according to the present invention formed from the blank of FIG. 15. FIG. 17 is a top view and FIG. 18 is a side view of the embodiment of the assembled toothbrush holder shown in FIG. 16. These views illustrate that various aesthetic changes can be made to the invention.

The present invention is directed to a collapsible, disposable toothbrush holder 10 formed from a blank 12, preferably a cardboard blank. The blank 10 is formed into the toothbrush holder 10 by folding the blank 12 along fold lines, gluing certain panels together, and then completing the formation by additional folds. After certain initial folds of the blank have been completed, and the certain panels have been glued together, the uncompleted toothbrush holder 10 can be shipped and stored in a flattened position, ready to be expanded and completed by the user into the finished toothbrush holder 10. The representative example of the holder 10 disclosed herein is a box-like structure having four sides, a top and a bottom. Other embodiments can have as few as three sides and as many sides as desired.

Referring now to FIGS. 1-3, a general basic embodiment of the holder 10 is shown. Several suitable embodiments of a holder 10 constructed in accordance with aspects of the present invention are illustrated in the figures. Specific details of the blank 12 and resulting holder 10 are described with more particularity below.

FIG. 1 is a perspective view of an assembled holder 10 according to the present invention. As can be seen, the holder 10 is a generally truncated pyramidal shape having sides 22, 23, 24, 25, bottom 26, and top 27. In effect, holder 10 is a hollow box-like structure. Top 27 has holes 14 therethrough allowing access to the interior of holder 10 through which a toothbrush 16, preferably a toothbrush handle or shank, may be inserted.

FIG. 2 is a top view of the embodiment of the assembled holder 10 shown in FIG. 1 illustrating an exemplary positioning of holes 14. As will be seen later, holes 14 can be any shape, so long as holes 14 can accommodate a toothbrush 16, and present in any quantity. Four round holes 14 are shown in FIG. 2 as being a preferred embodiment.

FIG. 3 is a side view of the embodiment of the assembled holder 10 shown in FIG. 1 better illustrating the trapezoidal shape of the sides, such as front side 24. Side 24 is referred to as front side 24 for spatial relationship purposes only, as holder 10 does not have a particular side 22, 23, 24, 25 that necessarily is the front. Other sides 22, 23, 25 also will be given spatially descriptive names so as to make this specification more easily understood. Although sides 22, 23, 24, 25, can be of many different shapes including but not limited to squares, rectangles and inverted trapezoids, it has been found that the trapezoidal shape shown in the figures provides pleasing aesthetics as well as allowing for a larger bottom 26 for greater stability.

FIG. 3 also shows an embodiment of holder suitable for advertising purposes, as represented by the “Your Ad Here” wording. Print, designs, photographs and other graphic and tactile devices can be added to the holder 10 for advertising and ornamental purposes.

FIG. 4 depicts a blank 12 used to form the holder 10. The blank 12 is preferably constructed from a single piece of formable or foldable material such as, without limitation, sheets of cellulose-based materials formed from cellulose materials such as wood pulp, straw, cotton, or the like. Cellulose-based materials used in this present invention come in many forms such as but not limited to cardboard and paperboard. The blank 12 is cut and scored, perforated or otherwise formed to include a plurality of panels 20 though 33 that when assembled form holder 10. Score lines as shown as solid lines between panels 20 through 33. For the purpose of further description herein, the downward direction (bottom) is defined as the direction perpendicular downward relative to the outer surface of the bottom 26 panel when the holder 10 has been erected (see FIGS. 1 and 3). The upward direction (top) is defined as the direction perpendicular upward relative to the outer surface of the top 27 panel when the holder 10 has been erected (see FIGS. 1 and 3).

Blank 12 includes bottom 26 panel. In this illustrative embodiment, bottom 26 panel is square. Attached to one side of bottom 26 panel along fold line 2629 is first tab 29. Attached to another side of bottom 26 panel opposite first tab 29 and along fold line 2226 is back side 22 panel. In this illustrative embodiment, back side 22 panel is trapezoidal, with bottom 26 panel being attached to the longer parallel side of the trapezoid, and top 27 panel being attached to the shorter parallel side of the trapezoid. Attached to another side of back side 22 panel opposite bottom 26 panel along fold line 2227 is top 27 panel. In this illustrative embodiment, top 27 panel is square. Attached to another side of top 27 panel opposite back side 22 panel and along fold line 2728 is second tab 28. Thus, first tab 29, bottom 26 panel, back side 22 panel, top 27 panel, and second tab 29 lie generally linearly with respect to each other.

Attached to another side of back side 22 panel along fold line 2122 is adhering or glue panel 21. In this illustrative embodiment, glue panel 21 is trapezoidal, with back side 22 panel and glue panel 21 being attached to each other along non-parallel sides. As will be discussed later, the exterior surface of glue panel 21 is glued or otherwise adhered to the interior surface of right side 25 panel to form the holder 10. Attached to another side of glue panel 21 opposite back side 22 panel along fold line 2021 is divider panel 20. In this illustrative embodiment, divider panel 20 is trapezoidal, with divider panel 20 and glue panel 21 being attached to each other along non-parallel sides. As will be discussed later, divider panel 20 is used to divide the interior of holder 10 into two interior volumes or sections.

Attached to another side of back side 22 panel along fold line 2223 is left side 23 panel. In this illustrative embodiment, left side 23 panel is trapezoidal, with left side 23 panel and back side 22 panel being attached to each other along non-parallel sides. Attached to another side of left side 23 panel along fold line 2324 is front side 24 panel. In this illustrative embodiment, front side 24 panel is trapezoidal, with front side 24 panel and left side 23 panel being attached to each other along non-parallel sides. Attached to another side, the top side, of left side 23 panel along fold line 2330 is third tab 30. In this illustrative embodiment, third tab 30 is generally trapezoidal, with the longer parallel side of third tab 30 being attached to the shorter parallel side of left side 23 panel. Third tab 30 comprises a semi-circular or arcuate notch 36 along the shorter parallel side opposite from left side 23 panel to cooperate with one of holes 14 as discussed later. Attached to another side, the bottom side, of left side 23 panel along fold line 2332 is fourth tab 32. In this illustrative embodiment, fourth tab 32 is generally trapezoidal, with the longer parallel side of fourth tab 32 being attached to the longer parallel side of left side 23 panel.

Attached to another side of front side 24 panel along fold line 2425 is right side 25 panel. In this illustrative embodiment, right side 25 panel is trapezoidal, with front side 24 panel and right side 25 panel being attached to each other along non-parallel sides. Attached to another side, the top side, of right side 25 panel along fold line 2531 is fifth tab 31. In this illustrative embodiment, fifth tab 31 is generally trapezoidal, with the longer parallel side of fifth tab 31 being attached to the shorter parallel side of right side 25 panel. Fifth tab 31 comprises a semi-circular or arcuate notch 36 along the shorter parallel side opposite from right side 25 panel to cooperate with one of holes 14 as discussed later. Attached to another side, the bottom side, of right side 25 panel along fold line 2533 is sixth tab 33. In this illustrative embodiment, sixth tab 33 is generally trapezoidal, with the longer parallel side of sixth tab 33 being attached to the longer parallel side of right side 25 panel.

Sides 22, 23, 24, 25 and glue panel 21 have generally the same shape and size as each other. Divider panel 20 is somewhat larger than sides 22, 23, 24, 25, and glue panel 21. Third tab 30 and fifth tab 31 have generally the same shape and size as each other. Fourth tab 32 and sixth tab 33 have generally the same shape and size as each other.

FIGS. 5-7 illustrate the formation of the holder 10 from the blank 12. FIGS. 5 and 6 illustrate a flattened holder 10 and FIG. 7 illustrates an expanded holder 10 ready for completion. Initially, all of the panels 20 through 33 are folded generally inward along the fold lines, with inward being out of the paper showing FIG. 4 towards the viewer.

Divider panel 20, glue panel 21, back side 21 panel, left side 22 panel, front side 23 panel, and right side 25 panel are folded inwardly relative to each other along fold lines 2021, 2122, 2223, 2324, 2425, respectively. The folding is done such that divider panel 20 will be located within the interior of holder 10, glue panel 21 and right side 25 panel will overlap and cooperate with each other, and back side 22 panel, left side 23 panel, front side 24 panel, and right side 25 panel will form a generally box-like structure. After folding, divider panel edge 2020 will contact or be proximal to the interior side of fold line 2223, the exterior surface of glue panel 21 will contact the interior surface of right side 25 panel, the exterior side of fold line 2021 will contact or be proximal to the interior side of fold line 2425, and right side edge 2525 will contact or be proximal to fold line 2122. Interior surface means the surface facing inwardly towards the interior of holder 10, exterior surface means the surface facing outwardly away from the interior of holder 10, interior side means the side facing inwardly towards the interior of holder 10, and exterior side means the side facing outwardly away from the interior of holder 10.

To secure holder 10 in the generally box-like configuration, glue panel 21 and right side 25 panel are secured together. More specifically, the exterior surface of glue panel 21 is secured to the interior surface of right side 25 panel. Any suitable adherent, can be used. As a preferred embodiment of holder 10 is for holding toothbrushes 16, the adherent preferably is non-toxic and non-allergenic to humans. Once glue panel 21 and right side 25 panel are secured together, the uncompleted holder 10 can be flattened for storage or shipping and can resemble FIGS. 5 and 6. The expanded uncompleted holder 10 can resemble FIG. 7.

FIG. 5 is a first view of the assembled blank shown in FIG. 4 in a flattened configuration. In this view, it can be seen that left side 23 panel is lying in front of and is the same general size and shape of back side 22 panel, which cannot be seen, and that front side 24 panel is lying in front of and is the same general size and shape as right side 25 panel, which also cannot be seen.

FIG. 6 is a second view of the assembled blank shown in FIG. 4 in a flattened configuration. In this view, in a manner similar to FIG. 5, it can be seen that right side 25 panel is lying in front of and is the same general size and shape of front side 24 panel, which cannot be seen, and that back side 22 panel is lying in front of and is the same general size and shape as left side 23 panel, which also cannot be seen. In this view, the overlapping relationship of right side 25 panel and glue panel 21 can be seen.

FIG. 7 is a perspective view of a partially assembled (expanded) holder 10 according to the present invention. In this view, the box-like structure an be better seen. Third tab 30 and fifth tab 31 are shown being folded slightly inward on their way to being folded to a generally horizontal position in the assembled holder 10. Likewise, fourth tab 32 and sixth tab 33 also are shown being folded slightly inward on their way to being folded to a generally horizontal position in the assembled holder 10. First tab 29 and bottom side 26 panel also are shown being folded slightly inward. In the assembled holder 10, first tab 29 will be inserted to a position in the interior of holder 10 with the exterior surface of first tab 29 contacting the interior surface of front side 24 panel, and bottom side 26 panel will lie in a generally horizontal position. Likewise, second tab 28 and top side 27 panel also are shown being folded slightly inward. In the assembled holder 10, second tab 28 will be inserted to a position in the interior of holder 10 with the exterior surface of second tab 28 also contacting the interior surface of front side 24 panel, and top side 27 panel will lie in a generally horizontal position. Divider panel 20 can be seen extending diagonally across the interior of holder 10 so as to divide the interior of holder 10 into two sub-volumes.

FIG. 8 is a top view of a partially assembled container according to the present invention. Top side 27 panel, second tab 28, third tab 30, and fifth tab 31 have been folded outwardly so as to give a better view of the interior of holder 10. Divider panel 20 can be seen extending diagonally across the interior of holder 10 dividing the interior of holder 10 into two volumes. A purpose of divider panel 20 is to act as a resting or restraining wall for toothbrushes 16 such that toothbrushes 16 placed through certain of holes 14 will not slide all of the way across the interior of holder 10 and therefore will stand more vertically in holder 10. Likewise divider panel 20 can separate two or more toothbrushes 16 from each other, preventing the toothbrushes 16 from touching each other, resulting in better hygiene.

The overlap of right side 25 panel and glue panel 21 can be seen in greater detail in FIG. 8. When assembled, third tab 30 and fifth tab 31 will be folded approximately 180 degrees inwardly from the position shown in FIG. 8 and will lie generally horizontally above the interior of holder 10. Top side 27 panel also will be folded approximately 180 degrees inwardly from the position shown in FIG. 8 and also will lie generally horizontally above the interior of holder 10 above third tab 30 and fifth tab 31. In the assembled position, notches 36 will cooperate with holes 14 such that third tab 30 and fifth tab 31 do not block any portion, or at least any operative portion, of holes 14. As such, the radius of notches 36 preferably is equal to or larger than the radius of holes 14.

FIG. 9 is a side view of a partially assembled holder 10 according to the present invention illustrating representative final assembly steps. In this view, second tab 28 and top side 27 panel, and first tab 29 and bottom side 26 panel, are shown being folded to the final position. Second tab 28 will be inserted into the interior of holder 10 with the exterior surface of second tab 28 contacting or being proximal to the interior surface of front side 24 panel. Similarly, first tab 29 will be inserted into the interior of holder 10 with the exterior surface of first tab 29 contacting or being proximal to the interior surface of front side 24 panel. Top side 27 panel then will lie generally horizontal at the top of holder 10 and bottom side 26 panel will lie generally horizontal at the bottom of holder 10. The top side 27 panel is configured to completely cover the top opening of holder 10, and the bottom side 26 panel is configured to completely cover the bottom opening of holder. This, in effect, will close the box-like structure of holder 10.

FIG. 10 is a sectional top view of the embodiment of the assembled toothbrush holder along line 10′-10′ of FIG. 3. In this view, the overlapping relationship between right side 25 panel and glue panel 21 can be seen.

FIG. 11 is a bottom view of an embodiment of the assembled holder 10 according to the present invention showing bottom side 26 panel.

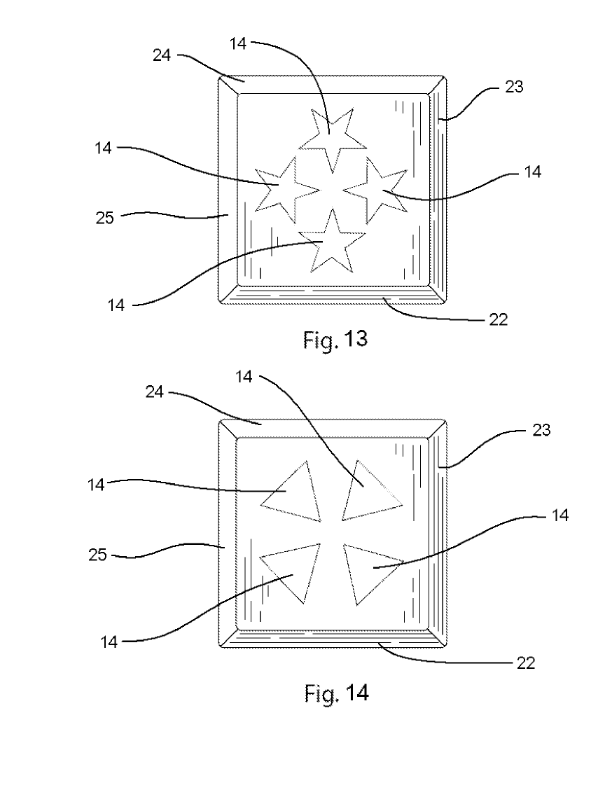

FIGS. 12-18 show alternate embodiments of the invention. FIG. 12 is a top view of an alternate embodiment of the assembled holder 10 according to the present invention showing square holes 14. FIG. 13 is a top view of an alternate embodiment of the assembled holder 10 according to the present invention showing star-shaped holes 14. FIG. 14 is a top view of an alternate embodiment of the assembled holder 10 according to the present invention showing triangular holes 14.

FIG. 15 is a view of a blank for forming an alternate embodiment of the tooth brush holder according to the present invention. In this alternative embodiment, fold line 2324 has been replaced with two curved fold lines 2324A, 2324B. When assembled, fold lines 2324A, 2324B will result in a curved edge 50 for ornamental purposes. FIG. 16 is a perspective view of an assembled holder 10 according to the present invention formed from the blank of FIG. 15 and showing the curved edge 50. FIG. 17 is a top view of the embodiment of the assembled holder 10 shown in FIG. 16 and FIG. 18 is a side view of the embodiment of the assembled holder 10 shown in FIG. 16 showing the curved edge 50. More than one curved edge 50 can be made by replacing other fold lines with curved fold lines.

In use, the completed (assembled or expanded) holder 10 can be placed on a surface and be used for supporting toothbrushes 16. The holder 10 can be supplied by an innkeeper or the like to patrons, can be purchased by the ultimate user for personal use, can be given out or sold by commercial entities with advertising thereon for promotional purposes, as well as used in many other ways. As the holder 10 can be supplied in a flattened configuration, it is easy to ship and to store, and it is easy to carry in a briefcase or suitcase. At the location of use, the holder can be supplied in the expanded form. If carried by the ultimate user, the user can bring the holder 10 with them in a flattened configuration and expanded when it is desired to be used. After use, the holder 10 can be flattened and discarded or, preferably, recycled.

The foregoing detailed description of the preferred embodiments and the appended figures have been presented only for illustrative and descriptive purposes. They are not intended to be exhaustive and are not intended to limit the scope and spirit of the invention. The embodiments were selected and described to best explain the principles of the invention and its practical applications. One skilled in the art will recognize that many variations can be made to the invention disclosed in this specification without departing from the scope and spirit of the invention.

What is claimed is:

1. A blank for forming a collapsible and disposable toothbrush holder, the blank comprising a plurality of panels and a plurality of fold lines between the panels, wherein:
a) at least three of the panels are side panels of the holder;
b) at least one of the panels is a top panel of the holder;
c) at least one of the panels is a bottom panel of the holder;
d) at least one of the panels is an adhering panel and is of the same general size and shape of one of the sides and is for adhering to one of the sides for forming the holder;
e) at least one of the panels is a divider panel for dividing an interior volume of the holder into two sub-volumes; and
f) at least two of the panels are tabs.

2. The blank as claimed in claim 1, wherein the side panels, the adhering panel, and the divider panel are located sequentially on the blank relative to each other and are distinguished form each other by certain of the fold lines, the top panel extends from one of the side panels and is distinguished therefrom by one of the fold lines, and the bottom panel extends from one of the side panels and is distinguished therefrom by one of the fold lines.

3. The blank as claimed in claim 1, wherein the top panel has at least one hole therethrough.

4. The blank as claimed in claim 2, wherein the top panel and the bottom panel extend from the same side panel.

5. The blank as claimed in claim 1, wherein the side panels, the adhering panel, and the divider panel are trapezoidal in shape and the folding lines separating the panels from each other are located along non-parallel sides of the panels.

6. The blank as claimed in claim 1, wherein one of the tabs extends from the top panel, one of the tabs extends from the bottom panel, and at least one of the tabs extends from at least one of the side panels.

7. The blank as claimed in claim 1, wherein:
i) the bottom panel is square;
ii) attached to one side of the bottom panel along a fold line is first tab;
iii) attached to another side of the bottom panel opposite the first tab and along a fold line is trapezoidal back side panel, with the bottom panel being attached to longer parallel side of the trapezoid, and with the top panel being attached to a shorter parallel side of the trapezoid;
iv) attached to another side of the back side panel opposite the bottom panel and along a fold line is the top panel, which is square;
v) attached to another side of the top panel opposite the back side panel and along a fold line is second tab;
vi) attached to another side of the back side panel and along a fold line is the adhering panel, which is trapezoidal, with the back side panel and the adhering panel being attached to each other along non-parallel sides;
vii) attached to another side of the adhering panel opposite the back side panel and along a fold line is the divider panel, which is trapezoidal, with the divider panel and the adhering panel being attached to each other along non-parallel sides;
viii) attached to another side of the back side panel and along a fold line is left side panel, which is trapezoidal, with the left side panel and the back side panel being attached to each other along non-parallel sides;
ix) attached to another side of the left side panel and along a fold line is front side panel, which is trapezoidal, with the front side panel and the left side panel being attached to each other along non-parallel sides;
x) attached to another side of the left side panel and along a fold line is third tab, which is generally trapezoidal, with a longer parallel side of the third tab being attached to a shorter parallel side of the left side panel;
xi) attached to another side of the left side panel and along a fold line is fourth tab, which is generally trapezoidal, with a longer parallel side of the fourth tab being attached to a longer parallel side of the left side panel
xii) attached to another side of the front side panel and along a fold line is right side 25 panel, which is trapezoidal, with the front side panel and the right side panel being attached to each other along non-parallel sides;
xiii) attached to another side of the right side panel and along a fold line is fifth tab, which is generally trapezoidal, with a longer parallel side of the fifth tab being attached to a shorter parallel side of the right side panel; and
xiv) attached to another side of the right side panel and along a fold line is sixth tab, which is generally trapezoidal, with a longer parallel side of the sixth tab being attached to a longer parallel side of the right side panel,
wherein the side panels and the adhering panel have generally the same shape and size as each other, the divider panel is larger than the side panels and the adhering panel.

8. A collapsible and disposable toothbrush holder formed from a blank, the holder comprising:
a) at least three side panels connected to each other in a generally linear manner and distinguished therefrom by a fold line;
b) at least one top panel connected to one of the side panels and distinguished therefrom by a fold line;
c) at least one bottom panel connected to one of the side panels and distinguished therefrom by a fold line;
d) at least one adhering panel that is of the same general size and shape of one of the sides and that is for adhering to one of the sides for forming the holder, the adhering panel being connected to one of the side panels and distinguished therefrom by a fold line; and
e) at least one divider panel for dividing an interior volume of the holder into two sub-volumes, the dividing panel being connected to the adhering panel and distinguished therefrom by a fold line,
wherein:
i) the divider panel, the adhering panel, and the side panels are folded inwardly relative to each other along the fold lines such that the divider panel is located within the holder;
ii) the adhering panel and one of the side panels overlap with and are adhered to each other;
iii) the side panels, the top panel, and the bottom panel form a generally box-like structure; and
iv) the top panel has at least one hole therethrough allowing access to the interior of the holder and through which a toothbrush can be placed.

9. The holder as claimed in claim 8, wherein an exterior surface of the adhering panel is secured to an interior surface of one of the side panels.

10. The holder as claimed in claim 9, wherein the top panel and the bottom panel extend from the same side panel.

11. The holder as claimed in claim 9, wherein the side panels, the adhering panel, and the divider panel are trapezoidal in shape and the folding lines separating the panels from each other are located along non-parallel sides of the panels.

12. The holder as claimed in claim 8, further comprising tabs, wherein one of the tabs extends from the top panel, one of the tabs extends from the bottom panel, and at least one of the tabs extends from at least one of the side panels.

13. The holder as claimed in claim 12, wherein the tab that extend from the top panel secures the top panel in a closed position proximal to top edges of the side panels and the tab that extends from the bottom panel secures the bottom panel in a closed position proximal to bottom edges of the side panels.

14. The holder as claimed in claim 8, wherein the holder is expandable from a flattened configuration to an expanded configuration for use, wherein in the expanded configuration the holder will support at least one toothbrush.

15. The holder as claimed in claim 14, wherein the holder has a truncated pyramidal shape in the expanded configuration.

16. The holder as claimed in claim 15, wherein the holder is formed from a blank comprising a plurality of the panels and a plurality of the fold lines between the panels, wherein:
a) at least three of the panels are the side panels of the holder;
b) at least one of the panels is the top panel of the holder;
c) at least one of the panels is the bottom panel of the holder;
d) at least one of the panels is the adhering panel and is of the same general size and shape of one of the sides and is for adhering to one of the sides for forming the holder;
e) at least one of the panels is the divider panel for dividing the interior volume of the holder into two sub-volumes; and
f) at least two of the panels are tabs.

17. The holder as claimed in claim 8, wherein:
i) the bottom panel is square;
ii) attached to one side of the bottom panel along a fold line is first tab;
iii) attached to another side of the bottom panel opposite the first tab and along a fold line is trapezoidal back side panel, with the bottom panel being attached to longer parallel side of the trapezoid, and with the top panel being attached to a shorter parallel side of the trapezoid;
iv) attached to another side of the back side panel opposite the bottom panel and along a fold line is the top panel, which is square;
v) attached to another side of the top panel opposite the back side panel and along a fold line is second tab;
vi) attached to another side of the back side panel and along a fold line is the adhering panel, which is trapezoidal, with the back side panel and the adhering panel being attached to each other along non-parallel sides;
vii) attached to another side of the adhering panel opposite the back side panel and along a fold line is the divider panel, which is trapezoidal, with the divider panel and the adhering panel being attached to each other along non-parallel sides;
viii) attached to another side of the back side panel and along a fold line is left side panel, which is trapezoidal, with the left side panel and the back side panel being attached to each other along non-parallel sides;
ix) attached to another side of the left side panel and along a fold line is front side panel, which is trapezoidal, with the front side panel and the left side panel being attached to each other along non-parallel sides;
x) attached to another side of the left side panel and along a fold line is third tab, which is generally trapezoidal, with a longer parallel side of the third tab being attached to a shorter parallel side of the left side panel;
xi) attached to another side of the left side panel and along a fold line is fourth tab, which is generally trapezoidal, with a longer parallel side of the fourth tab being attached to a longer parallel side of the left side panel
xii) attached to another side of the front side panel and along a fold line is right side 25 panel, which is trapezoidal, with the front side panel and the right side panel being attached to each other along non-parallel sides;
xiii) attached to another side of the right side panel and along a fold line is fifth tab, which is generally trapezoidal, with a longer parallel side of the fifth tab being attached to a shorter parallel side of the right side panel; and
xiv) attached to another side of the right side panel and along a fold line is sixth tab, which is generally trapezoidal, with a longer parallel side of the sixth tab being attached to a longer parallel side of the right side panel,
wherein the side panels and the adhering panel have generally the same shape and size as each other, the divider panel is larger than the side panels and the adhering panel.

18. The holder as claimed in claim 8, further comprising two fold lines between two of the side panels resulting in a curved side edge between the two side panels.

19. A collapsible and disposable advertising media comprising:
a) at least three side panels connected to each other in a generally linear manner and distinguished therefrom by a fold line;
b) at least one top panel connected to one of the side panels and distinguished therefrom by a fold line;
c) at least one bottom panel connected to one of the side panels and distinguished therefrom by a fold line;
d) at least one adhering panel that is of the same general size and shape of one of the sides and that is for adhering to one of the sides for forming the holder, the adhering panel being connected to one of the side panels and distinguished therefrom by a fold line; and
e) at least one divider panel for dividing an interior volume of the holder into two sub-volumes, the dividing panel being connected to the adhering panel and distinguished therefrom by a fold line,
wherein:
i) the divider panel, the adhering panel, and the side panels are folded inwardly relative to each other along the fold lines such that the divider panel is located within the holder;
ii) the adhering panel and one of the side panels overlap with and are adhered to each other;
iii) the side panels, the top panel, and the bottom panel form a generally box-like structure;
iv) the top panel has at least one hole therethrough allowing access to the interior of the holder and through which a toothbrush can be placed;
v) advertising and/or promotional material is located on at least one of the side panels and/or top panel.

20. The advertising media as claimed in claim 19, wherein the side panels have generally the same size and shape as each other.
